(19) United States
(12) Patent Application Publication
(10) Pub. No.: US 2020/0042066 A1
(43) Pub. Date: Feb. 6, 2020

(54) SYSTEM AND METHOD FOR FACILITATING DRAM DATA CACHE DUMPING AND RACK-SCALE BATTERY BACKUP

(71) Applicant: Alibaba Group Holding Limited, George Town (KY)

(72) Inventor: Shu Li, Bothell, WA (US)

(73) Assignee: Alibaba Group Holding Limited, George Town (KY)

(21) Appl. No.: 16/210,997

(22) Filed: Dec. 5, 2018

Related U.S. Application Data
(60) Provisional application No. 62/713,908, filed on Aug. 2, 2018.

(51) Int. Cl. G06F 1/30; G06F 11/14; G06F 3/06

(52) U.S. Cl. CPC G06F 1/30; G06F 11/1451; G06F 3/0679; G06F 3/0658; G06F 3/0617

(57) ABSTRACT

One embodiment facilitates data storage. During operation, the system receives data to be stored in a non-volatile memory of a storage device associated with a host, wherein a region of a volatile memory of the host is configured as a cache accessible by a controller of the storage device. The system writes the data to the cache region to obtain cached data. In response to detecting a fault of the host: the system retrieves, by the controller from the cache region, the cached data; and the system writes, by the controller, the cached data to the non-volatile memory of the storage device.

### RELATED APPLICATION

This application claims the benefit of U.S. Provisional Application No. 62/713,908, Attorney Docket No. ALI-A15932USP, titled “System and Method of DRAM Data Cache Dumping and Simplified SSD With Rack-Scale Battery-Backed System,” by inventor Shu Li, filed 2 Aug. 2018, the disclosure of which is incorporated herein by reference in its entirety.

### BACKGROUND

### Field

This disclosure is generally related to the field of data storage. More specifically, this disclosure is related to a system and method for facilitating dynamic random access memory (DRAM) data cache dumping and a rack-scale battery backup system.

### Related Art

The proliferation of the Internet and e-commerce continues to create a vast amount of digital content. Various storage systems and servers have been created to access and store such digital content. In cloud or clustered storage systems, multiple applications may share the underlying system resources (e.g., of a storage device). Managing the resources of a storage device is critical for the performance of the system. Furthermore, the latency involved in performing a transaction (such as an input/output (I/O) request) can affect the performance, including the query per second (QPS) and transaction per second (TPS) rates. In many applications, there may be a need to reduce the latency associated with processing or accessing data, e.g., to satisfy any Quality of Service (QoS) requirements (e.g., in a service level agreement) or in an online transaction processing (OLTP) system. Furthermore, many applications require persistent storage of data to ensure both coherency and sequence. A single transaction to write data cannot be successfully performed or completed until the data has been written in a synchronized manner to a non-volatile memory of a storage device, e.g., a solid state drive (SSD) or a hard disk drive (HDD). As a result, the write latency can be a dominating and limiting factor in the performance of an application.

As a storage module, an SSD is connected to a host (and its central processing unit (CPU)) via a Peripheral Interconnect Express (PCIe) bus. This physical arrangement results in a long I/O path and an increased latency. In contrast, system memory (such as dynamic random access memory dual in-line memory module (DRAM DIMM)) is located physically close to the host CPU, with an access latency which is typically one to two orders of magnitude lower than the access latency of an SSD. However, DRAM DIMM is a volatile memory which can suffer from faults, e.g., power loss and a crash of the operating system.

One current solution includes an NVDIMM-N, which is a non-volatile DIMM and Not-And (NAND), which combines DRAM and NAND together. During a fault, data in DRAM is flushed to NAND, and when the system recovers from the fault, that data is then flushed back to DRAM from NAND. However, this current solution has a number of shortcomings. First, the financial cost can be significant because NVDIMM-N is equipped with additional parts, including a battery, a specific NVDIMM-N controller, NAND and NAND flash. Second, the amount of power consumed by the NVDIMM-N typically exceeds the amount of power assigned to each DIMM slot. Third, the NVDIMM-N battery is a shared battery which must be charged and discharged periodically, which can lead to an increased complexity in maintenance. Fourth, the NVDIMM-N battery can experience decay and lead to a high yearly fault rate. Thus, the shortcomings of NVDIMM-N can result in an increased financial cost (both in the overall cost of the NVDIMM-N and in the cost in module replacement and maintenance personnel), an increased burden in the power supply and thermal dissipation, and an increased complexity in maintenance.

Thus, while the current solution provides persistent storage using a combined system of DIMM and NAND, the current solution has many shortcomings and cannot provide a low-latency persistent storage which is highly desirable by applications which seek to deliver a significant improvement in performance. In addition, a low-latency persistent storage can be beneficial to the overall efficiency of a cloud or a clustered storage system, and may also positively impact the scalability of a distributed storage system.

### SUMMARY

One embodiment facilitates data storage. During operation, the system receives data to be stored in a non-volatile memory of a storage device associated with a host, wherein a region of a volatile memory of the host is configured as a cache accessible by a controller of the storage device. The system writes the data to the cache region to obtain cached data. In response to detecting a fault of the host: the system retrieves, by the controller from the cache region, the cached data; and the system writes, by the controller, the cached data to the non-volatile memory of the storage device.

In some embodiments, wherein subsequent to writing the data to the cache region to obtain the cached data, the system sends, to the host, an acknowledgment that the data is successfully committed, and asynchronously writes the cached data to the non-volatile memory of the storage device.

In some embodiments, writing the data to the cache region to obtain the cached data further includes writing the data to one or more physical pages in the cache region. Furthermore, subsequent to asynchronously writing the cached data to the non-volatile memory of the storage device, the system marks as available the one or more physical pages in the cache region.

In some embodiments, writing the data to the cache region, sending the acknowledgment, and asynchronously writing the cached data to the non-volatile memory are performed while in a normal mode.

In some embodiments, in response to detecting a power loss: the system switches from a power supply associated with the detected power loss to a battery unit that provides power to a rack, which is associated with the host and the storage device; the system sends, to a system operator, a notification which indicates the detected power loss; and the system continues any ongoing operations of the host in a normal mode.

In some embodiments, the rack is further associated with a plurality of other hosts and a plurality of other storage devices, and the host, the other hosts, the storage device, and the other storage devices share the battery unit.

In some embodiments, the storage device includes a solid state drive (SSD), the non-volatile memory of the storage device includes Not-And (NAND) physical media, and the storage device and the other storage devices associated with the rack each do not include its own power loss protection module or its own volatile memory.

In some embodiments, in response to detecting the fault of the host: the system switches from a normal mode to a copy mode; and the system grants permission to the controller to access the cached data in the cache region, wherein granting permission to the controller, the controller retrieving the cached data, and the controller writing the cached data to the non-volatile memory of the storage device are performed while in the copy mode.

In some embodiments, in response to detecting that the fault is fixed, the system switches from the copy mode to the normal mode.

### BRIEF DESCRIPTION OF THE FIGURES

FIG. 1 illustrates an exemplary environment for facilitating data storage, in accordance with an embodiment of the present application.

FIG. 2 illustrates an exemplary environment for facilitating data storage, including the structure of a NVDIMM-N, in accordance with the prior art.

FIG. 3 illustrates an exemplary environment for facilitating data storage, including a scheme in which an SSD controller accesses data in a configured reserved region of the host DIMM, in accordance with an embodiment of the present application.

FIG. 4A presents an exemplary environment for facilitating data storage, including communications which occur in a normal mode of the host, in accordance with an embodiment of the present application.

FIG. 4B presents an exemplary environment for facilitating data storage, including communications which occur in response to detecting a fault in the host, in a copy mode of the host, in accordance with an embodiment of the present application.

FIG. 5A presents a flowchart illustrating a method for facilitating data storage, in accordance with an embodiment of the present application.

FIG. 5B presents a flowchart illustrating a method for facilitating data storage, in accordance with an embodiment of the present application.

FIG. 6 illustrates an exemplary computer system that facilitates measurement of the performance of a storage drive, in accordance with an embodiment of the present application.

FIG. 7 illustrates an exemplary apparatus that facilitates measurement of the performance of a storage drive, in accordance with an embodiment of the present application.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

### Overview

The embodiments described herein provide a system which facilitates a low-latency persistent storage by configuring a region of host DIMM as a data cache which is directly accessible by an SSD controller, and by simplifying the SSD by providing a rack-scale shared battery unit.

Many applications require a low-latency persistent storage, e.g., in an OLTP or to satisfy any QoS requirements. In the conventional systems, an SSD is connected to a host via a PCIe bus, which results in a long I/O path and an increased latency for write operations. In contrast, system memory (e.g., host DRAM DIMM) is located physically close to the host CPU, with a lower access latency than that of an SSD. However, DRAM DIMM is a volatile memory which can suffer from faults, e.g., power loss and a crash of the operating system.

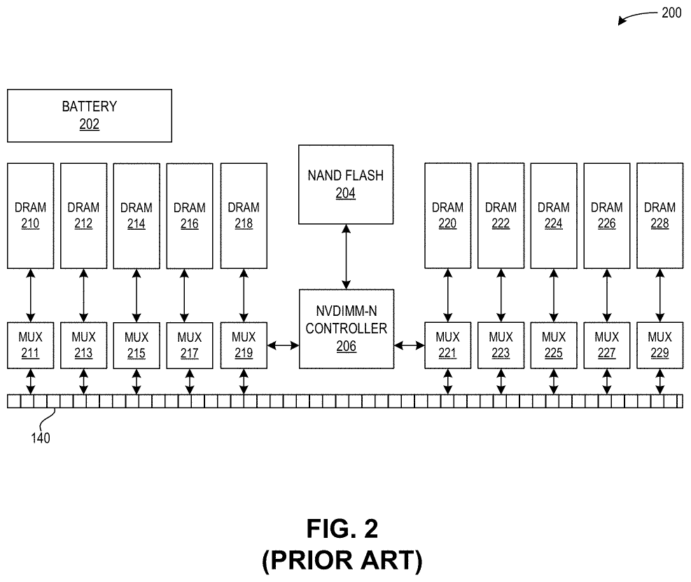

One current solution includes an NVDIMM-N, which is a non-volatile DIMM and NAND. During a fault, data in DRAM is flushed to NAND, and when the system recovers from the fault, that data is then flushed back to DRAM from NAND. However, this current solution has a number of shortcomings. First, the financial cost can be significant because NVDIMM-N is equipped with additional parts, including a battery, a specific NVDIMM-N controller, and NAND flash. This cost can be multiple times greater than a standard DRAM DIMM. Second, the amount of power consumed by the NVDIMM-N typically exceeds the amount of power assigned to each DIMM slot, which can result in an increased burden in power supply and the thermal dissipation. Third, the NVDIMM-N battery is a shared battery (i.e., shared by all the components in the NVDIMM-N) which must be charged and discharged periodically. This can lead to an increased complexity in maintenance because the system must identify and configure multiple groups at different times for the periodic charge/discharge in order to ensure high availability. Fourth, the NVDIMM-N battery can experience decay and lead to a high yearly fault rate, which can result in an increased cost in module replacement and maintenance personnel. An exemplary NVDIMM-N is described below in relation to FIG. 2.

Thus, while the current solution provides persistent storage using a combined system of DIMM and NAND, the current solution has many shortcomings and cannot provide a low-latency persistent storage which is highly desirable by applications which seek to deliver a significant improvement in performance. In addition, a low-latency persistent storage can be beneficial to the overall efficiency of a cloud or a clustered storage system, and may also positively impact the scalability of a distributed storage system.

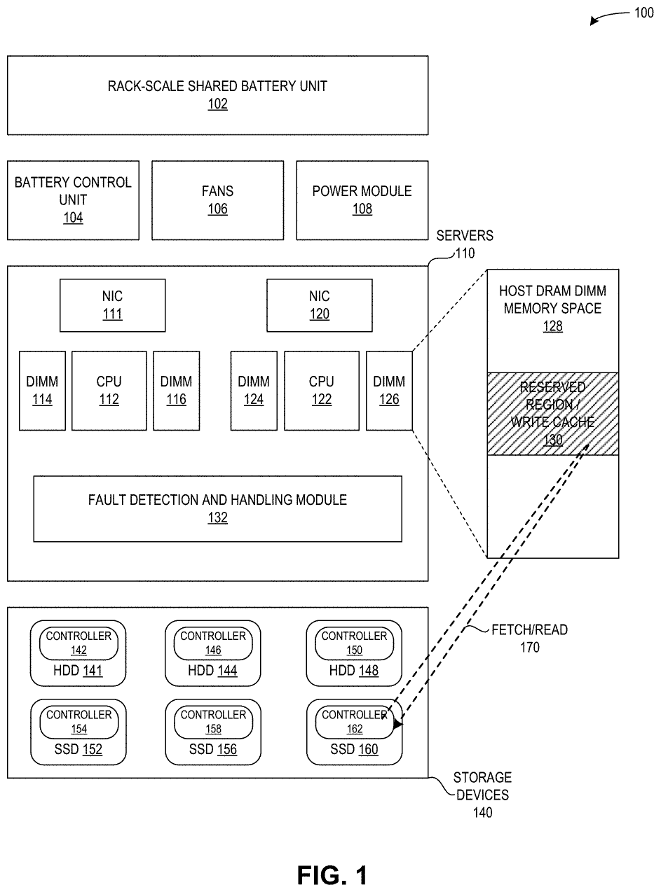

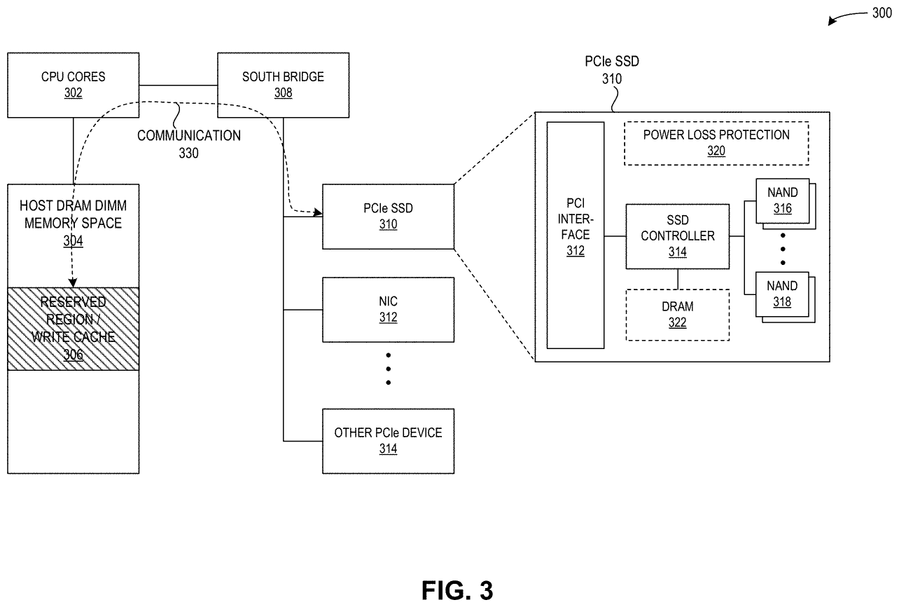

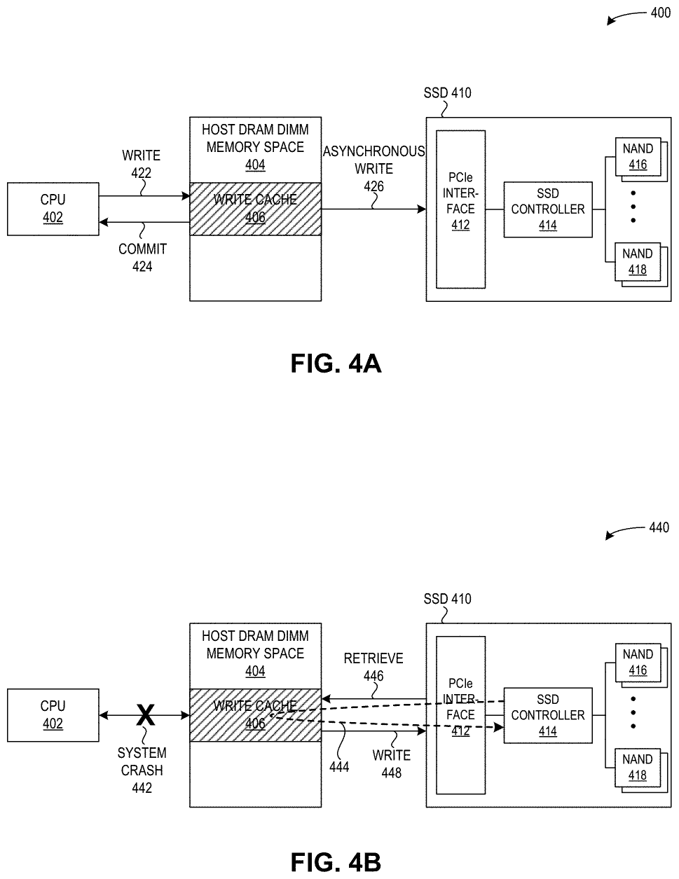

The embodiments described herein provide a system which addresses these challenges by configuring a region of host DIMM as a data cache (“cache region”) which is directly accessible by an SSD controller, while simplifying the SSD by providing a rack-scale shared battery unit. In response to detecting a fault, the system allows the SSD controller to retrieve previously cached data from the cache region of the host DIMM, and to write that data to the NAND. Thus, the host DIMM and the SSD work together to provide the low-latency persistent storage, and are also both supported by a rack-scale battery. By configuring the cache region to serve as the data cache, and by providing the rack-scale battery, the embodiments described herein can include a simplified SSD which does not need to include either an internal DRAM or a power loss module. An exemplary architecture is described below in relation to FIGS. 1 and 3, while exemplary communications during a normal operation and in response to detecting a fault are described below in relation to, respectively, FIGS. 4A and 4B.

Thus, the embodiments described herein provide a system which improves and enhances the efficiency and performance of a storage system. By configuring a region of host DIMM as a data cache which is directly accessible by an SSD controller, and by providing a rack-scale shared battery unit, the system can provide a low-latency persistent storage using a simplified SSD. The embodiments described herein also provide a technological solution (as described above) to a technological problem (providing low-latency persistent storage).

The terms “data cache,” “data cache region,” “cache region,” “reserved region,” “reserved area,” “configured region,” and “configured area” are used interchangeably in this disclosure and refer to a region or area of system memory, such as host DRAM DIMM. This region or area can be configured or reserved as a write cache. For example, incoming write data can be stored temporarily in this write cache, and the SSD controller can be granted permission to retrieve previously cached data from this write cache in the event of a fault, as described herein.

The term “normal mode” refers to when the system is operating without a fault, or in response to not detecting any fault, and unaffected by a power loss. The term “copy mode” refers to when the system is operating in response to detecting a fault, such as a system crash, an error which prevents the system from operating under normal procedures/circumstances, or circumstances which prevent communication by or with the CPU or any other component required for completing a given transaction or request. While in copy mode, the SSD controller can access data from the data cache and write that data to the NAND, as described herein.

### Exemplary Environment and Network

FIG. 1 illustrates an exemplary environment 100 for facilitating data storage, in accordance with an embodiment of the present application. Environment 100. Environment 100 can include: a rack-scale shared battery unit 102; a battery control unit 104; fans 106; a power module 108; servers 110; and storage devices 140. Servers 110 can include: a CPU 112, DIMMs 114 and 116, and a network interface card (NIC) 111; and a CPU 122, DIMMs 124 and 126, and a NIC 120. Servers 110 can also include a fault detection and handling module 132, which can manage the movement of data among tiers of storage devices. Servers 110 can communicate via a network with a client computing device (not shown). Servers 110 can also be a part of distributed storage system which can include multiple storage servers in communication with multiple client servers (not shown). Servers 110 can also be associated with a single rack, and can share the resources of components 102-108.

Storage devices 140 can include multiple storage drives or devices. Each storage drive, such as a solid state drive (SSD) or a hard disk drive (HDD), can include a controller and multiple physical media for data storage. For example, an SSD can include NAND physical media for storage, and an HDD can include physical media with multiple tracks for storage. Storage devices 140 can include: hard disk drives (HDDs) 141, 144, and 148 (with, respectively, controllers 142, 146, and 150); and SSDs 152, 156, and 160 (with, respectively, controllers 154, 158, and 162).

The system can configure or reserve a region or area of a DIMM to serve as a data cache, and can further grant permission to an SSD controller to directly access cached data in response to detecting a fault. For example, DIMM 126 can include a host DRAM DIMM memory space 128. The system can configure a reserved region/write cache (“cache region”) 130 of host DRAM DIMM memory space 128. When a fault occurs, such as an operating system crash, the system can allow SSD controller 162 to retrieve any previously cached data in cache region 130 (via a fetch/read communication 170), and write that retrieved data to NAND, as described below in relation to FIG. 4B. Subsequently, when the system has recovered from the fault, the SSD controller can move any of the retrieved data back to the cache region, as needed.

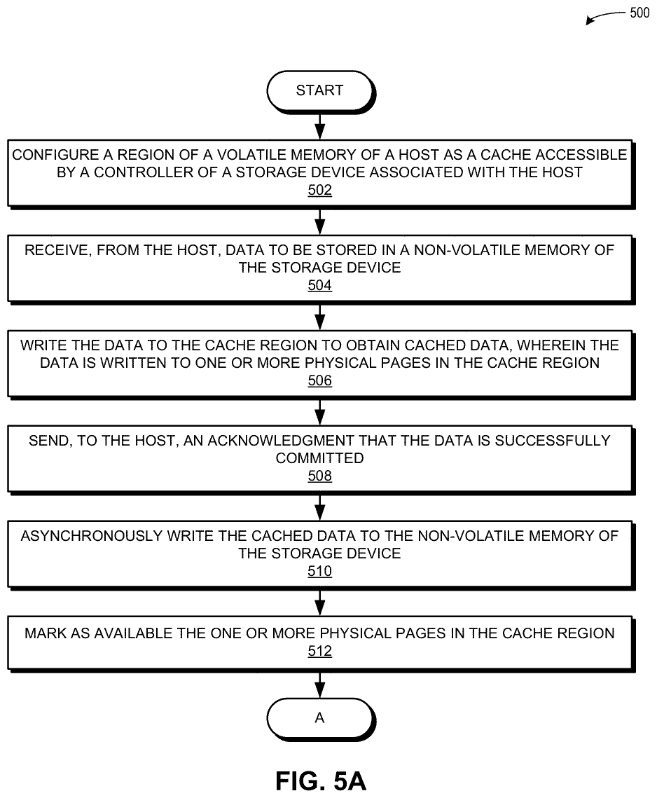

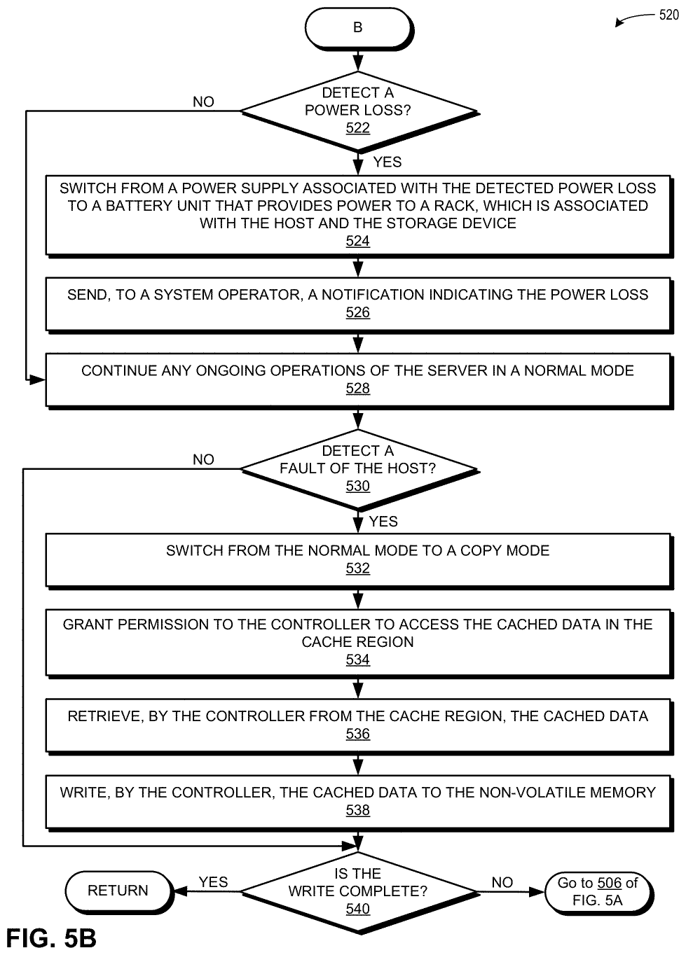

Furthermore, rack-scale shared battery unit 102 is a rack-level resource which provides a redundant power supply to the components associated with the rack, including servers 110 and storage devices 140. Rack-scale shared battery unit 102 can provide sufficient power to support the power consumption required by the associated components for, e.g., tens of minutes. When a power loss is detected (e.g., by power module 108 of a main power supply (not shown)), the system can switch the power path from the main power supply to rack-scale shared battery unit 102. This allows the system to continue performing any ongoing operations in a normal mode, without needing to trigger or activate any of the prior power loss handling methods, such as flushing data from DRAM to NAND. When the power loss is detected, the system can also send a notification indicating the power loss to a system operator, which allows the system operator a time on the order of tens of minutes to identify and implement a solution to the problem of the detected power loss. Detecting and handling a power loss is described below in relation to FIG. 5B.

### Exemplary Environment and Challenges of the Prior Art (NVDIMM-N)

FIG. 2 illustrates an exemplary environment 200 for facilitating data storage, including the structure of an NVDIMM-N, in accordance with the prior art. Environment 200 can represent a circuit board which includes both volatile memory (e.g., DRAM) as well as non-volatile persistent storage (e.g., NAND). For example, environment 200 can include: a battery 202; a NAND flash 204; an NVDIMM-N controller; multiple DRAM modules 210-228, which can be accessed via, respectively, multiplexers 211-229 (e.g., “mux” 211); and gold fingers 140 of the circuit board.

As discussed above, NVDIMM-N can provide a solution for a low-latency non-volatile storage by, during a fault, flushing data in DRAM to NAND, and, upon a recovery from the fault, flushing that data back to DRAM from NAND. However, several shortcomings exist with the NVDIMM-N solution, which include: 1) significant financial cost due to the additional parts on the NVDIMM-N, e.g., battery 202, NAND flash 204, and the specific NVDIMM-N controller 206; 2) the amount of power consumed by the NVDIMM-N of environment 200 typically exceeds the amount of power assigned to each DIMM slot, which can result in an increased burden in power supply and the thermal dissipation; 3) battery 202 is a shared battery (i.e., shared by all the components in the NVDIMM-N) which must be charged and discharged periodically, and can lead to an increased complexity in maintenance; and 4) battery 202 can experience decay and lead to a high yearly fault rate, which can result in an increased cost in module replacement and maintenance personnel.

### SSD Controller Accesses Data in Reserved Region of Host DIMM; Rack-Scale Shared Battery Unit

FIG. 3 illustrates an exemplary environment 300 for facilitating data storage, including a scheme in which an SSD controller accesses data in a configured reserved region of the host DIMM, in accordance with an embodiment of the present application. Environment 300 can include: CPU cores 302; DRAM DIMM (i.e., a host DRAM DIMM memory space 304) with a configured reserved region/write cache (“cache region”) 306; a south bridge 308; a PCIe SSD 310; a NIC 312; and another PCIe device 314. PCIe SSD 310 can include: a PCIe interface 312; an SSD controller 314; and NANDs 316 and 318. PCIe SSD 310 is a simplified SSD of the embodiments described herein, and no longer requires its own power loss protection module 320 or internal DRAM 322 (as depicted by the dotted-line boxes).

During operation, the system can use cache region 306 (of the host DRAM DIMM) as a temporary data buffer, and, in response to a fault, PCIe SSD 310 (via SSD controller 314) can retrieve data previously cached in cache region 306 (via a communication 330) and store the data in its NAND (e.g., NANDs 316 and 318). A exemplary communication in response to handling a fault is described below in relation to FIG. 4B. By using cache region 306 as its temporary data buffer, PCIe SSD 310 does not need its own internal DRAM 322. Furthermore, because PCIe SSD 310 can be part of a rack which uses a rack-scale shared battery (as described above in relation to FIG. 1), PCIe SSD 310 does not need its own power loss protection module 320.

Thus, environment 300 depicts how cache region 306 is used in combination with PCIe SSD 310, and how this combination functions as a non-volatile block device using a rack-scale battery.

FIG. 4A presents an exemplary environment 400 for facilitating data storage, including communications which occur in a normal mode of the host, in accordance with an embodiment of the present application. Environment 400 can include a CPU 402, a host DRAM DIMM memory space 404 with a write cache (a reserved “cache region”) 406, and an SSD 410, which includes a PCIe interface 412, an SSD controller 414, and NANDs 416 and 418. During a normal mode of operation (i.e., no fault occurs or is detected), an application can write data to write cache 406 (via a write 422 communication) and immediately send an acknowledgment that the data is successfully committed (via a commit 424 communication). At a subsequent or different time, i.e., asynchronously, the system can write the cached data to NANDs 416-418 of SSD 410 (via an asynchronous write 426 communication).

FIG. 4B presents an exemplary environment 440 for facilitating data storage, including communications which occur in response to detecting a fault in the host, in a copy mode of the host, in accordance with an embodiment of the present application. Environment 440 can include similar components as in environment 400. During operation, when a fault occurs or is detected (e.g., a system crash 442, which stops communication with/by the CPU, the system can switch from the normal mode to a copy mode. The system can grant permission to the SSD controller to access write cache 406. That is, SSD controller 414 can initiate a data copy from the reserved cache region to its NAND. SSD controller 414 can obtain or retrieve data from a pre-set address in cache region 406, e.g., via installed firmware (via a retrieve 446 communication), and write that “retrieved data” to SSD NAND flash, NANDs 416-418 (via a write 448 communication). Communications 446 and 448 are shown together in a single dashed loop communication 444. Subsequently, when the system has recovered from the fault, the system can move the previously retrieved data from SSD NANDs 416-418 back to cache region 406, as needed. In some embodiments, the SSD controller may make a determination to move none, some, or all of the previously retrieved data back to cache region 406. This determination can be based on an access frequency of the data or any other indicator for the data.

### Exemplary Method for Facilitating Data Storage

FIG. 5A presents a flowchart 500 illustrating a method for facilitating data storage, in accordance with an embodiment of the present application. During operation, the system configures a region of a volatile memory of a host as a cache accessible by a controller of a storage device associated with the host (operation 502). In some embodiments, operation 502 may be performed by an entity other than the system, in which case a region of a volatile memory of the host is configured as a cache accessible by a controller of the storage device. The system receives, from the host, data to be stored in a non-volatile memory of the storage device (operation 504). The system writes the data to the cache region to obtain cached data, wherein the data is written to one or more physical pages in the cache region (operation 506). The system sends, to the host, an acknowledgment that the data is successfully committed (operation 508). The system asynchronously writes the cached data to the non-volatile memory of the storage device (operation 510). The system marks as available the one or more physical pages in the cache region (operation 512). The system can release the one or more physical pages such that other data may be subsequently written to those physical pages. The operation continues as described at Label A of FIG. 5B.

FIG. 5B presents a flowchart 520 illustrating a method for facilitating data storage, in accordance with an embodiment of the present application. During operation, if the system does not detect a power loss (decision 522), the operation continues at operation 528.

If the system detects a power loss (decision 522), the system switches from a power supply associated with the detected power loss to a battery unit that provides power to a rack, which is associated with the host and the storage device (operation 524). A rack can be further associated with a plurality of other hosts and storage devices, which all share the battery unit (e.g., as in rack-scale shared battery unit 102 in FIG. 1). The system can send, to a system operator, a notification indicating the power loss (operation 526), which allows the system operator to investigate the detected power loss and solve the problem before the system consumes and depletes the entirety of the amount of power provided by the rack-scale shared battery unit. The system can thus continue any ongoing operations of the server in a normal mode (operation 528).

If the system does not detect a fault of the host (decision 530), the operation continues at decision 540. If the system does detect a fault of the host (decision 530), the system switches from the normal mode to a copy mode (operation 532), and grants permission to the controller to access the cached data in the cache region (operation 534). The system retrieves, by the controller from the cache region, the cached data (operation 536). The system writes, by the controller, the cached data to the non-volatile memory of the storage device (operation 538).

If the write operation is complete (decision 540), the operation returns. If the write operation is not complete (decision 540), the operation continues at operation 506 of FIG. 5A.

### Exemplary Computer System and Apparatus

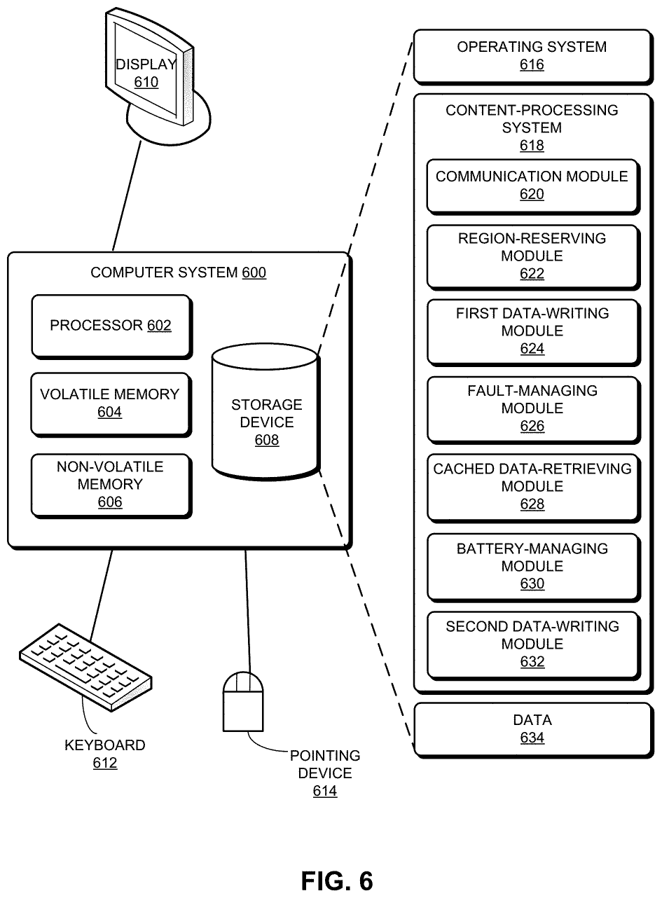

FIG. 6 illustrates an exemplary computer system that facilitates measurement of the performance of a storage drive, in accordance with an embodiment of the present application. Computer system 600 includes a processor 602, a volatile memory 604, a non-volatile memory 606, and a storage device 608. Computer system 600 may be a computing device or a storage device. Volatile memory 604 can include memory (e.g., RAM) that serves as a managed memory, and can be used to store one or more memory pools. Volatile memory 604 can include a configured or reserved cache region, as described herein. Non-volatile memory can be part of a storage device (e.g., an SSD) associated with computer system 600, and can include NAND flash physical media. Computer system 600 can be coupled to a display device 610, a keyboard 612, and a pointing device 614. Storage device 608 can store an operating system 616, a content-processing system 618, and data 634.

Content-processing system 618 can include instructions, which when executed by computer system 600, can cause computer system 600 to perform methods and/or processes described in this disclosure. For example, content-processing system 618 can include instructions for receiving and transmitting data packets, including a request to write or read data, an I/O request, data to be encoded and stored, a block or a page of data, or cached data.

Content-processing system 618 can further include instructions for configuring a region of a volatile memory of a host as a cache accessible by a controller of a storage device associated with the host (region-reserving module 622). Content-processing system 618 can include instructions for receiving data to be stored in a non-volatile memory of the storage device (communication module 620). Content-processing system 618 can include instructions for writing the data to the cache region to obtain cached data (first data-writing module 624). Content-processing system 618 can include instructions for, in response to detecting a fault of the host (fault-managing module 626): retrieving, by the controller from the cache region, the cached data (cached data-retrieving module 628); and writing, by the controller, the cached data to the non-volatile memory of the storage device (second data-writing module 632).

Content-processing system 618 can include instructions for sending, to the host, an acknowledgment that the data is successfully committed (communication module 620). Content-processing system 618 can include instructions for asynchronously writing the cached data to the non-volatile memory of the storage device (second data-writing module 632).

Content-processing system 618 can include instructions for, in response to detecting a power loss (fault-managing module 626): switching from a power supply associated with the detected power loss to a battery unit that provides power to a rack, which is associated with the host and the storage device (battery-managing module 630); sending, to a system operator, a notification which indicates the detected power loss (communication module 620); and continuing any ongoing operations of the host in a normal mode (fault-managing module 626).

Data 634 can include any data that is required as input or that is generated as output by the methods and/or processes described in this disclosure. Specifically, data 634 can store at least: data to be stored, written, loaded, moved, retrieved, accessed, deleted, or copied; a data cache; a temporary data buffer; a reserved or pre-configured region; a request to write data; a latency for completing an I/O operation; an indicator of a controller of a storage device; a physical page of data; an acknowledgment that data is successfully committed; an indicator of a detected power loss; a normal mode; a copy mode; an indicator of a rack, a host, or a storage device; an indicator of a rack-scale shared battery unit; a notification which indicates a detected power loss; an indicator of granting permission to a controller to access a reserved region of host DIMM; and an indicator of a fault or that the fault is fixed.

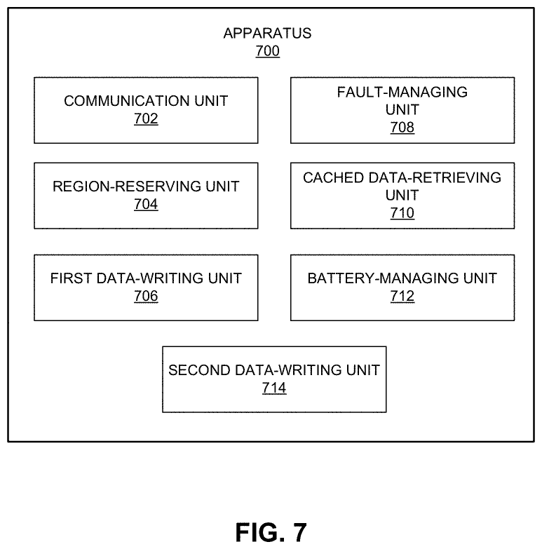

FIG. 7 illustrates an exemplary apparatus 700 that facilitates measurement of the performance of a storage drive, in accordance with an embodiment of the present application. Apparatus 700 can comprise a plurality of units or apparatuses which may communicate with one another via a wired, wireless, quantum light, or electrical communication channel. Apparatus 700 may be realized using one or more integrated circuits, and may include fewer or more units or apparatuses than those shown in FIG. 7. Further, apparatus 700 may be integrated in a computer system, or realized as a separate device which is capable of communicating with other computer systems and/or devices. Specifically, apparatus 700 can comprise units 702-714 which perform functions or operations similar to modules 620-632 of computer system 600 of FIG. 6, including: a communication unit 702; a region-reserving unit 704; a first data-writing unit 706; a fault-managing unit 708; a cached data-retrieving unit 710; a battery-managing unit 712; and a second data-writing unit 714.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing embodiments described herein have been presented for purposes of illustration and description only. They are not intended to be exhaustive or to limit the embodiments described herein to the forms disclosed. Accordingly, many modifications and variations will be apparent to practitioners skilled in the art. Additionally, the above disclosure is not intended to limit the embodiments described herein. The scope of the embodiments described herein is defined by the appended claims.

What is claimed is:

1. A computer-implemented method for facilitating data storage, the method comprising:
receiving data to be stored in a non-volatile memory of a storage device associated with a host,
wherein a region of a volatile memory of the host is configured as a cache accessible by a controller of the storage device;
writing the data to the cache region to obtain cached data; and
in response to detecting a fault of the host:
retrieving, by the controller from the cache region, the cached data; and
writing, by the controller, the cached data to the non-volatile memory of the storage device.

2. The method of claim 1, wherein subsequent to writing the data to the cache region to obtain the cached data, the method further comprises:
sending, to the host, an acknowledgment that the data is successfully committed; and
asynchronously writing the cached data to the non-volatile memory of the storage device.

3. The method of claim 2, wherein writing the data to the cache region to obtain the cached data further includes writing the data to one or more physical pages in the cache region, and wherein the method further comprises:
subsequent to asynchronously writing the cached data to the non-volatile memory of the storage device, marking as available the one or more physical pages in the cache region.

4. The method of claim 2, wherein writing the data to the cache region, sending the acknowledgment, and asynchronously writing the cached data to the non-volatile memory are performed while in a normal mode.

5. The method of claim 1, further comprising:
in response to detecting a power loss:
switching from a power supply associated with the detected power loss to a battery unit that provides power to a rack, which is associated with the host and the storage device;
sending, to a system operator, a notification which indicates the detected power loss; and
continuing any ongoing operations of the host in a normal mode.

6. The method of claim 5,
wherein the rack is further associated with a plurality of other hosts and a plurality of other storage devices, and
wherein the host, the other hosts, the storage device, and the other storage devices share the battery unit.

7. The method of claim 6,
wherein the storage device includes a solid state drive (SSD),
wherein the non-volatile memory of the storage device includes Not-And (NAND) physical media, and
wherein the storage device and the other storage devices associated with the rack each do not include its own power loss protection module or its own volatile memory.

8. The method of claim 1, wherein in response to detecting the fault of the host, the method further comprises:
switching from a normal mode to a copy mode; and
granting permission to the controller to access the cached data in the cache region,
wherein granting permission to the controller, the controller retrieving the cached data, and the controller writing the cached data to the non-volatile memory of the storage device are performed while in the copy mode.

9. The method of claim 8, further comprising:
in response to detecting that the fault is fixed, switching from the copy mode to the normal mode.

10. A computer system for facilitating data storage, the system comprising:
a processor; and
a memory coupled to the processor and storing instructions, which when executed by the processor cause the processor to perform a method, the method comprising:
receiving data to be stored in a non-volatile memory of a storage device associated with a host,
wherein a region of a volatile memory of the host is configured as a cache accessible by a controller of the storage device;
writing the data to the cache region to obtain cached data; and
in response to detecting a fault of the host:
retrieving, by the controller from the cache region, the cached data; and
writing, by the controller, the cached data to the non-volatile memory of the storage device.

11. The computer system of claim 10, wherein subsequent to writing the data to the cache region to obtain the cached data, the method further comprises:
sending, to the host, an acknowledgment that the data is successfully committed; and
asynchronously writing the cached data to the non-volatile memory of the storage device.

12. The computer system of claim 11, wherein writing the data to the cache region to obtain the cached data further includes writing the data to one or more physical pages in the cache region, and wherein the method further comprises:
subsequent to asynchronously writing the cached data to the non-volatile memory of the storage device, marking as available the one or more physical pages in the cache region.

13. The computer system of claim 11, wherein writing the data to the cache region, sending the acknowledgment, and asynchronously writing the cached data to the non-volatile memory are performed while in a normal mode.

14. The computer system of claim 10, wherein the method further comprises:
in response to detecting a power loss:
switching from a power supply associated with the detected power loss to a battery unit that provides power to a rack, which is associated with the host and the storage device;
sending, to a system operator, a notification which indicates the detected power loss; and
continuing any ongoing operations of the host in a normal mode.

15. The computer system of claim 14,
wherein the rack is further associated with a plurality of other hosts and a plurality of other storage devices, and
wherein the host, the other hosts, the storage device, and the other storage devices share the battery unit.

16. The computer system of claim 15,
wherein the storage device includes a solid state drive (SSD),
wherein the non-volatile memory of the storage device includes Not-And (NAND) physical media, and
wherein the storage device and the other storage devices associated with the rack each do not include its own power loss protection module or its own volatile memory.

17. The computer system of claim 10, wherein in response to detecting the fault of the host, the method further comprises:
switching from a normal mode to a copy mode; and
granting permission to the controller to access the cached data in the cache region,
wherein granting permission to the controller, the controller retrieving the cached data, and the controller writing the cached data to the non-volatile memory of the storage device are performed while in the copy mode.

18. The computer system of claim 17, wherein the method further comprises:
in response to detecting that the fault is fixed, switching from the copy mode to the normal mode.

19. An apparatus for facilitating data storage, the apparatus comprising:
a communication module configured to receive data to be stored in a non-volatile memory of a storage device associated with a host,
wherein a region of a volatile memory of the host is configured as a cache accessible by a controller of the storage device;
a first data-writing module configured to write the data to the cache region to obtain cached data;
a fault-detecting module configured to detect a fault of the host; and
in response to the fault-detecting module detecting a fault of the host:
a cached-data retrieving module configured to retrieve, from the cache region, the cached data; and
a second data-writing module configured to write the cached data to the non-volatile memory of the storage device.

20. The apparatus of claim 19, wherein subsequent to the first data-writing module writing the data to the cache region to obtain the cached data, the apparatus further comprises:
wherein the communication module is further configured to send, to the host, an acknowledgment that the data is successfully committed; and
wherein the second data-writing module is further configured to asynchronously write the cached data to the non-volatile memory of the storage device;
wherein the fault-detecting module is further configured to detect a power loss, and wherein:
in response to the fault-detecting module detecting a power loss:
wherein the fault-detecting module is further configured to switch from a power supply associated with the detected power loss to a battery unit that provides power to a rack, which is associated with the host and the storage device;
wherein the communication module is further configured to send, to a system operator, a notification which indicates the detected power loss; and
wherein the apparatus is configured to continue any ongoing operations of the host in a normal mode; and
wherein the storage device is a solid state drive (SSD),
wherein the non-volatile memory of the storage device includes Not-And (NAND) physical media, and
wherein the storage device does not include its own power loss protection module or its own volatile memory.
